(19) United States
(12) Patent Application Publication
(10) Pub. No.: US 2009/0274921 A1
(43) Pub. Date: Nov. 5, 2009

(54) TERPOLYMER WITH HIGH MELTING POINT

(76) Inventors: Nina Ackermans, Tessenderlo (BE); Mark De Ryck, Scherpenheuvel (BE); Guido Boelaers, Overpelt (BE)

Correspondence Address: MCANDREWS HELD & MALLOY, LTD, 500 WEST MADISON STREET, SUITE 3400, CHICAGO, IL, 60661, US

(21) Appl. No.: 12/476,379

(22) Filed: Jun. 2, 2009

Related U.S. Application Data
(63) Continuation of application No. PCT/EP2007/063729, filed on Dec. 11, 2007.

(30) Foreign Application Priority Data
Dec. 18, 2006 (EP) 06026211.0

(51) Int. Cl. B32B 27/08; C08F 10/14; C08F 10/04; C08F 210/00

(52) U.S. Cl. 428/516; 526/348.2; 526/348.6; 526/348

(57) ABSTRACT

Terpolymer of propylene, ethylene and C₄ to C₈ α-olefin with good barrier properties and processing properties, wherein the amount of propylene in said terpolymer is at least 94 percent by weight and the melting temperature of said terpolymer is more than 140° C.

### RELATED APPLICATIONS

This application is a continuation of International Application Serial No. PCT/EP2007/063729 (International Publication Number WO 2008/074699 A1), having an International filing date of Dec. 11, 2007 entitled “Terpolymer with High Melting Point”. International Application No. PCT/EP2007/063729 claimed priority benefits, in turn, from European Patent Application No. 06026211.0, filed Dec. 18, 2006. International Application No. PCT/EP2007/063729 and European Application No. 06026211.0 are hereby incorporated by reference herein in their entireties.

### FEDERALLY SPONSORED RESEARCH OR DEVELOPMENT

[Not Applicable]

### MICROFICHE/COPYRIGHT REFERENCE

[Not Applicable]

### FIELD OF THE INVENTION

The present technology relates to a new propylene terpolymer suitable as a metallised biaxially oriented polypropylene (BOPP) film and its manufacture as well as its use.

### BACKGROUND OF THE INVENTION

In the field of food packing there is a continuous need for metallised biaxially oriented polypropylene (BOPP) films with excellent barrier properties to improve the shelf life of the sealed products, like coffee, potato chips, cookies and the like.

Commercially available polypropylenes used for metallised biaxially oriented polypropylene (BOPP) films have several drawbacks, i.e. cannot combine good processing properties with good end properties, like barrier properties. However to make a product commercially attractive it must be easily producible, i.e. inter alia no surface cracking of the film shall occur during converting and/or winding processes. Moreover it must be ensured that a smooth film surface is obtained as well as that an extrusion lamination of the terpolymer to other substrates without forming crazes during the process is possible. Additionally, of course, the barrier properties of such films must be satisfactory. Commonly known terpolymers do not combine good processing properties with good end properties but suffer mostly from brittle surfaces leading to crazes or have inferior barrier properties.

WO 98/58971 discloses a terpolymer of propylene, ethylene and a C₄ to C₈ α-olefin having a melting temperature below 132° C. The terpolymer according to this patent application suffers in particular from low barrier properties caused by a rather high ethylene content.

U.S. Pat. No. 5,948,547 is directed to a composition comprising at least two propylene terpolymers with different ethylene and butene content. The composition is in particular specified by rather high amounts of comonomers, i.e. more than 10 wt %, in the total composition. However high amounts of comonomers lead to inferior barrier properties as well as to high amounts of xylene solubles.

U.S. Pat. No. 5,326,625 discloses a scalable, opaque, biaxially oriented multilayer polypropylene film, wherein the top layer can be a terpolymer. However also this terpolymer is characterized by high amounts of ethylene and shows therefore similar drawbacks as the terpolymers described above.

EP 0 674 991 A1 is concerned with a composition comprising at least two polymer types, wherein one of the two is a terpolymer. The composition is characterized in particular by a rather low melting point, i.e. not higher than 143° C. and high amounts of comonomers, i.e. more than 7 wt %.

### BRIEF SUMMARY OF THE INVENTION

Thus, considering the problems outlined above, it is an object of the present technology to provide a polypropylene material that is suitable as a skin layer of a biaxially oriented polypropylene (BOPP) multilayer film, in particular suitable as a skin layer of a metallised biaxially oriented polypropylene (BOPP) multilayer film. It is in particular of interest to provide a polypropylene which supports an easy processing to the multilayer film avoiding any crazes during the manufacture. Moreover the film on the basis of the new polypropylene preferably prolongs the shelf life of the food wrapped therein, i.e. the polypropylene shall have good barrier properties. Additionally it would be appreciated that the polypropylene ensures a good extrusion lamination process of the substrate.

In certain embodiments, the present technology provides a terpolymer comprising propylene, ethylene and C₄ to C₈ α-olefin. In certain embodiments, the amount of propylene in the terpolymer can be at least 94 percent by weight. In certain embodiments, the melting temperature of the terpolymer is more than 140° C. In certain embodiments, the terpolymer has been produced in the presence of a Ziegler-Natta catalyst.

Certain embodiments of the present technology provide a terpolymer comprising propylene, ethylene and C₄ to C₈ α-olefin, where the terpolymer comprises at least 94 percent by weight propylene, and the terpolymer comprises at least 5 percent by weight of a crystalline fraction. The crystalline fraction has an isotactic sequence length (“s”) between 34 and 49, where the fraction is determined by a stepwise isothermal segregation technique as follows:
a) the terpolymer is melted at 225° C. for 5 min.;
b) then cooled at a rate of 60° C./min to 145° C.;
c) held for 2 hours at 145° C.;
d) then cooled at a rate of 60° C./min to 135° C.;
e) held for 2 hours at 135° C.;
f) then cooled at a rate of 60° C./min to 125° C.;
g) held for 2 hours at 125° C.;
h) then cooled at a rate of 60° C./min to 115° C.;
i) held for 2 hours at 115° C.;
j) then cooled at a rate of 60° C./min to 105° C.;
k) held for 2 hours at 105° C.;
l) then cooled at a rate of 60° C./min to 20° C.; and
m) then heated at a heating rate of 10° C./min up to 200° C. to obtain a melting curve of said cooled terpolymer, wherein said melting curve is used to calculate, in a first step, the lamella thickness distribution according to the Thomson-Gibbs equation, and the isotactic sequence length.

In the first step, the Thomas Gibbs Equation is used as follows:

$${T}_{m} = {T}_{0} ( 1 - \frac{2 σ}{Δ {H}_{0} \cdot L} ) ;$$

wherein:
T₀=457 K;
ΔH₀=184×10⁶ J/m³;
σ=0.0496 J/m²;
Tₘ is the measured temperature (measured in degrees K); and
L is the lamella thickness (measured in nm).

In the second step, the isotactic sequence length is determined using the following equation:

s=L/(0.65·3);

wherein:
s is the isotactic sequence length; and
L is the lamella thickness.

Certain embodiments of the present technology provide methods for producing a terpolymer as described herein. Additionally, certain embodiments provide films comprising a core layer that has a high crystallinity polypropylene homopolymer, and a first skin layer adjacent to said core layer wherein said skin layer comprises a terpolymer, where the terpolymer is as described herein. Furthermore, the films can comprise a tie layer adjacent to the first skin layer comprising preferably maleic anhydride modified polypropylene homopolymer or copolymer. In certain embodiments they also comprise a metalized layer adjacent to the first skin or first tie layer and on a side of the skin or first tie layer opposite the core layer. Additionally, in certain embodiments the films comprise a second skin layer adjacent to said core layer and on a side of said core layer opposite said first skin layer. The films may be multilayer films, and in certain embodiments, the films may be used as part of an article that is lamination packaging.

### BRIEF DESCRIPTION OF SEVERAL VIEWS OF THE DRAWINGS

FIG. 1 is a graph the SIST Analysis of examples of terpolymers in accordance with the present technology.

### DETAILED DESCRIPTION OF THE INVENTION

An object of the present technology is to provide a terpolymer of rather high crystallinity with a rather broad compositional spread.

Accordingly, the present technology provides, in a first aspect, a terpolymer of propylene, ethylene and a C₄ to C₈ α-olefin, wherein:

a) the amount of propylene in said terpolymer is at least 94 wt.-% (percent by weight);

b) the melting temperature of said terpolymer is more than 140° C.; and

c) optionally the terpolymer has been produced in the presence of a Ziegler-Natta catalyst.

Preferably propylene, ethylene and a C₄ to C₈ α-olefin are the only monomers of the terpolymer of the present technology. The C₄ to C₈ α-olefin can be any α-olefin, i.e. branched or linear α-olefin, like 1-butene, 1-pentene, 4-methyl-l-pentene, 1-hexene, 1-heptene or 1-octene, however 1-butene is preferred.

Surprisingly, it has been found that a terpolymer with such features has superior properties compared to known terpolymers in this technical field. The terpolymer is in particular characterized to be less sensitive to surface defects during the processing of biaxially oriented polypropylene films and less sensitive to surface crazing during the manipulation of said films, like in metalizing said films. Achieved are these beneficial properties by a rather high melting temperature and rather low content of the remaining comonomers, i.e. of ethylene and C₄ to C₈ α-olefin, preferably 1-butene, present in the terpolymer. Moreover the terpolymer has improved barrier properties which further widen the applications of the terpolymer of the present technology.

The terpolymer of the present technology has a rather high content of propylene in the terpolymer, i.e. higher than 94 wt.-%. A rather high amount of propylene in the terpolymer indicates on the other hand rather low amounts of the other remaining comonomers, namely of ethylene and C₄ to C₈ α-olefin. Such a ratio of propylene to the other comonomers improves the crystallinity properties and improves additionally the barrier properties. Thus it is preferred that the propylene content in the terpolymer is at least 95 wt.-%, more preferred at least 96 wt.-% and yet more preferred at least 96.5 wt.-%.

As stated above not only the propylene content in the polymer is rather high but also the content of ethylene is rather low. A rather low amount of ethylene is beneficial for gas barrier properties of films produced from the polymer. Accordingly it is preferred that the ethylene content in the terpolymer is not more than 1.5 wt.-%, yet more preferred not more than 1.0 wt.-%. On the other hand ethylene is present in the terpolymer to reduce the surface brittleness to avoid surface cracking during film manipulation. Thus ethylene is at least detectable as defined below. However it is preferred that the ethylene content is at least 0.2 wt.-%, more preferred at least 0.3 wt.-%, still more preferred at least 0.4 wt.-%, and yet more preferred at least 0.5 wt.-%. A preferred range of ethylene in the terpolymer is 0.1 to 1.5 wt.-%, more preferred 0.3 to 1.2 wt.-%, yet more preferred 0.5 to 1.0 wt.-%.

For the C₄ to C₈ α-olefin, in particular 1-butene, applies similar considerations as for ethylene. Accordingly the content of C₄ to C₈ α-olefin, preferably 1-butene, in the terpolymer is rather low. A rather low amount of C₄ to C₈ α-olefin, preferably 1-butene, ensures a high melting temperature. Accordingly it is preferred that the content of C₄ to C₈ α-olefin, preferably 1-butene, in the terpolymer is below 4.0 wt.-%, more preferably below 3.5 wt.-%, yet more preferably not more than 3.0 wt.-%. On the other hand C₄ to C₈ α-olefin, preferably 1-butene, is present in the terpolymer to guarantee good processing properties and good metal adhesion. Thus C₄ to C₈ α-olefin, preferably 1-butene, is at least detectable as defined below. However it is preferred that the content of C₄ to C₈ α-olefin, preferably 1-butene, is at least 1.0 wt.-%, more preferred at least 1.3 wt.-%, still more preferred at least 1.6 wt.-%, and yet more preferred at least 2.0 wt.-%. A preferred range of C₄ to C₈ α-olefin, preferably 1-butene, in the terpolymer is 1.0 to 3.5 wt.-%, more preferred 1.5 to 3.2 wt.-%, yet more preferred 2.0 to 3.0 wt.-%.

The comonomer content, i.e. the content of propylene, ethylene and of C₄ to C8 α-olefin, preferably 1-butene, can be determined with FT infrared spectroscopy, as described below in the examples.

The melting temperature of the terpolymer is rather high, i.e. higher than 140° C. A high melting temperature of the terpolymer ensures a good extrusion lamination of the multilayer film. Thus it is preferred that the melting temperature is at least 143° C., more preferably at least 145° C. On the other hand the melting temperature should be not too high. Thus it is preferred that the melting temperature is not higher than 158° C., still more preferred not higher than 155° C. and yet more preferred not higher than 153° C. Preferably the melting temperature is in the range of 141 to 157° C., more preferably in the range of 142 to 155° C., still more preferably in the range of 145 to 152° C., and yet more preferably in the range of 145 to 151° C.

The stepwise isothermal segregation technique (SIST) provides a possibility to determine the lamellar thickness distribution and therewith the isotactic sequence length distribution of the terpolymer of the present technology. A significant amount of rather long isotactic sequence length “s” in the terpolymer improves the barrier properties of the same. Thus it is preferred that the terpolymer of the present technology comprises at least 5 wt-%, still more preferred at least 7 wt-%, yet more preferred at least 8 wt-%, still more preferred at least 10 wt-%, of a crystalline fraction with an isotactic sequence length “s” of more than 34 to less than 49, wherein said fraction is determined by stepwise isothermal segregation technique (SIST) as defined in the example section. In turn an upper limit of this fraction is appreciated. Accordingly it is preferred that the crystalline fraction with an isotactic sequence length “s” of more than 34 to less than 49 is below 30 wt.-%, more preferred below 25 wt.-%. A preferred range for the crystalline fraction with an isotactic sequence length “s” of more than 34 to less than 49 is 5 to 30 wt.-%, more preferred of 10 to 25 wt.-%.

On the other hand it is preferred that the terpolymer of the present technology is in particular characterized by a broad compositional spread, i.e. the terpolymer has a wide spread in isotactic sequence length “s”. Such a wide spread guarantees that on the one hand the gas permeability of a film based on said terpolymer is rather low and that on the other hand the terpolymer can easily be processed into a metallised biaxially oriented polypropylene film. Thus it is preferred that the terpolymer comprises additionally at least 5 wt.-%, more preferred at least 8 wt.-%, yet more preferred at least 10 wt.-%, still more preferred at least 12 wt.-%, of a crystalline fraction with an isotactic sequence length “s” of below 18. On the other hand the fraction should be not too big otherwise the barrier properties are negatively influenced. Thus it is preferred that the crystalline fraction with an isotactic sequence length “s” of below 18 is not more than 22 wt.-%, still more preferred not more than 20 wt.-%, yet more preferred not more than 18 wt.-%. A preferred range for the crystalline fraction with an isotactic sequence length “s” of below 18 is 5 to 20 wt.-%, more preferred of 10 to 18 wt.-%.

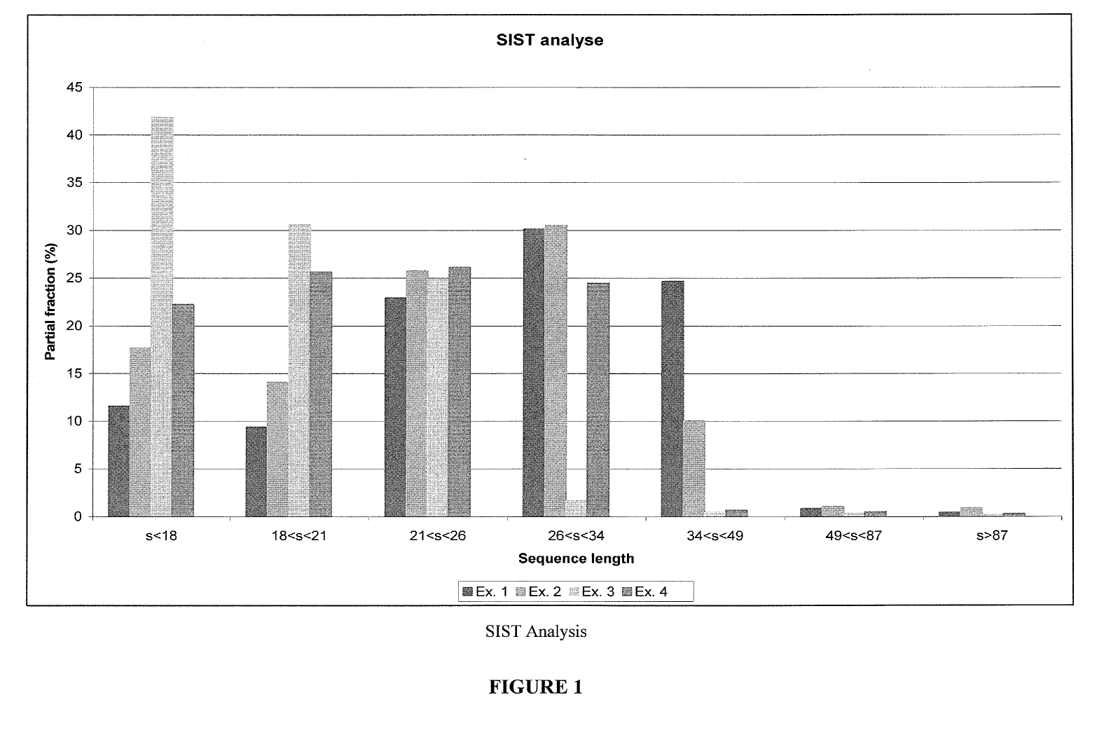

Of course it is preferred that the terpolymer of the present technology has not only crystalline fractions with a rather long isotactic sequence length “s”, i.e. of more than 34 to less than 49, and a rather short isotactic sequence length “s”, i.e. of below 18, but comprises also fractions with an isotactic sequence length falling in-between the two extremes (see FIG. 1).

Thus the following amounts for the fractions with an isotactic sequence length “s” of 18 to 21, 21 to 26, and 26 to 34 are preferred.

A preferred range for the crystalline fraction with an isotactic sequence length “s” of 18 to 21 is 5 to 20 wt.-%, more preferred of 8 to 15 wt.-%.

A preferred range for the crystalline fraction with an isotactic sequence length “s” of 21 to 26 is 15 to 30 wt.-%, more preferred of 20 to 26 wt.-%.

A preferred range for the crystalline fraction with an isotactic sequence length “s” of 26 to 34 is 20 to 35 wt.-%, more preferred of 25 to 32 wt.-%.

The Vicat softening temperature, like Vicat A50 at 10 N, reflects the heat softening characteristic of polymers. For the measurement a flat specimen is placed in a temperature regulated heating bath, a flat-ended needle is set on the specimen surface under a specific load and the bath temperature is raised at a constant rate. The temperature of the bath at which the penetration of the needle has reached a predefined level is the Vicat A50 softening temperature at 10 N according to ISO 306. The exact measuring method is determined in the example section.

Accordingly, the Vicat A50 temperature at 10 N is an appropriate parameter to define the terpolymer of the present technology with regard to its thermal behaviour. A higher Vicat A50 temperature at 10 N means a better thermal resistance of a surface. Thus it is appreciated that the terpolymer of the present technology leads to a high Vicat A50 temperature when formed into a film.

Accordingly, the terpolymer of the present technology has preferably a heat resistance measured according to ISO 306 Vicat A50 at 10 N of at least 127° C., more preferably of more than 129° C. and yet more preferably of more than 131° C.

According to a second aspect of the present technology a terpolymer of propylene, ethylene and a C₄ to C₈ α-olefin is provided, wherein:

a. the amount of propylene in said terpolymer is at least 94 wt.-% and

b) said terpolymer comprises at least 5 wt-% of a crystalline fraction with an isotactic sequence length “s” of more than 34 to less than 49, wherein said fraction is determined by stepwise isothermal segregation technique (SIST), wherein:
(i) said terpolymer is melted at 225° C. for 5 min.,
(ii) then cooled with 60° C./min to 145° C.
(iii) held for 2 hours at 145° C.,
(iv) then cooled with 60° C./min to 135° C.
(v) held for 2 hours at 135° C.,
(vi) then cooled with 60° C./min to 125° C.
(vii) held for 2 hours at 125° C.,
(viii) then cooled with 60° C./min to 115° C.
(ix) held for 2 hours at 115° C.,
(x) then cooled with 60° C./min to 105° C.
(xi) held for 2 hours at 105° C.,
(xii) then cooled down with 60° C./min to 20° C. and
(xiii) then heated at a heating rate of 10° C./min up to 200° C. obtaining a melting curve of said cooled terpolymer, wherein
said melting curve is used:

a) to calculate in a first step the lamella thickness distribution according to Thomson-Gibbs equation (Eq 1.)

$${T}_{m} = {T}_{0} ( 1 - \frac{2 σ}{Δ {H}_{0} \cdot L} ) \qquad ( 1 )$$

wherein:

T₀=457 K,

ΔH₀=184×10⁶ J/m³,

σ=0.0496 J/m²,

Tₘ is the measured temperature (K),

L is the lamella thickness (nm), and

(b) to calculate in a second step the isotactic sequence length “s” using the equation (Eq 2.)

s=L/(0.65·3) (2)

wherein:

s is the isotactic sequence length, and

L is the lamella thickness.

More information concerning the stepwise isothermal segregation technique (SIST) is given in the example section.

Preferably the terpolymer is produced in the presence of a Ziegler-Natta catalyst.

Preferably propylene, ethylene and a C₄ to C₈ α-olefin are the only monomers of the terpolymer of the present technology. The C₄ to C₈ α-olefin can be any α-olefin, i.e. branched and linear α-olefin, like 1-butene, 1-pentene, 4-methyl-1-pentene, 1-hexene, 1-heptene or 1-octene, however 1-butene is preferred.

Surprisingly, it has been found that a terpolymer with such features has superior properties compared to known terpolymers in this technical field. The terpolymer is in particular characterized to be less sensitive to surfaces defects during the processing of biaxially oriented polypropylene films and less sensitive to surface crazing during the manipulation of said films, like in metalizing said films. Achieved are these beneficial properties by a significant fraction of a long sequence length in the terpolymer and rather low content of the remaining comonomers, i.e. of ethylene and C₄ to C₈ α-olefin, preferably 1-butene, present in the terpolymer. Moreover the terpolymer has improved barrier properties which further widen the applications of the terpolymer of the present technology.

The terpolymer of the present technology has a rather high content of propylene in the terpolymer, i.e. higher than 94 wt.-%. A rather high amount of propylene in the terpolymer indicates on the other hand rather low amounts of the other remaining comonomers, namely of ethylene and C₄ to C₈ α-olefin. Such a ratio of propylene to the other comonomers improves the crystallinity properties and improves additionally the barrier properties. Thus it is preferred that the propylene content in the terpolymer is at least 95 wt.-%, more preferred at least 96 wt.-% and yet more preferred at least 96.5 wt.-%.

As stated above not only the propylene content in the polymer is rather high but also the content of ethylene is rather low. A rather low amount of ethylene is beneficial for gas barrier properties of films produced from the polymer. Accordingly it is preferred that the ethylene content in the terpolymer is not more than 1.5 wt.-%, yet more preferred not more than 1.0 wt.-%. On the other hand ethylene is present in the terpolymer to reduce the surface brittleness to avoid surface cracking during film manipulation. Thus ethylene is at least detectable as defined below. However it is preferred that the ethylene content is at least 0.2 wt.-%, more preferred at least 0.3 wt.-%, still more preferred at least 0.4 wt.-%, and yet more preferred at least 0.5 wt.-%. A preferred range of ethylene in the terpolymer is 0.1 to 1.5 wt.-%, more preferred 0.3 to 1.2 wt.-%, yet more preferred 0.5 to 1.0 wt.-%.

For the C₄ to C₈ α-olefin, in particular 1-butene, applies similar considerations as for ethylene. Accordingly the content of C₄ to C₈ α-olefin, preferably 1-butene, in the terpolymer is rather low. A rather low amount of C₄ to C₈ α-olefin, preferably 1-butene, ensures a high melting temperature. Accordingly it is preferred that the content of C₄ to C₈ α-olefin, preferably 1-butene, in the terpolymer is below 4.0 wt.-%, more preferably below 3.5 wt.-% and yet more preferably not more than 3.0 wt.-%. On the other hand C₄ to C₈ α-olefin, preferably 1-butene, is present in the terpolymer to guarantee good processing properties and good metal adhesion. Thus C₄ to C₈ α-olefin, preferably 1-butene, is at least detectable as defined below. However it is preferred that the content of C₄ to C₈ α-olefin, preferably 1-butene, is at least 1.0 wt.-%, more preferred at least 1.3 wt.-%, still more preferred at least 1.6 wt.-%, and yet more preferred at least 2.0 wt.-%. A preferred range of the C₄ to C₈ α-olefin, in particular 1-butene, in the terpolymer is 1.0 to 3.5 wt.-%, more preferred 1.5 to 3.2 wt.-%, yet more preferred 2.0 to 3.0 wt.-%.

The comonomer content, i.e. the content of propylene, ethylene and of C₄ to C₈ α-olefin, preferably 1-butene, can be determined with FT infrared spectroscopy, as described below in the examples.

The terpolymer has a considerable fraction of rather long isotactic sequence length “s”. The stepwise isothermal segregation technique (SIST) provides a possibility to determine the lamellar thickness distribution and therewith also the isotactic sequence length distribution of the terpolymer of the present technology. A significant amount of rather long isotactic sequence length “s” in the terpolymer improves the barrier properties of the same. Thus, the terpolymer of the present technology comprises at least 5 wt-%, preferably at least 7 wt-%, more preferably at least 8 wt-%, still more preferably at least 10 wt-%, of a crystalline fraction with an isotactic sequence length “s” of more than 34 to less than 49, wherein said fraction is determined by stepwise isothermal segregation technique (SIST) as defined above and in the example section. In turn it an upper limit of this fraction is appreciated. Accordingly it is preferred that the crystalline fraction with an isotactic sequence length “s” of more than 34 to less than 49 is below 30 wt.-%, more preferred below 25 wt.-%. A preferred range for the crystalline fraction with an isotactic sequence length “s” of more than 34 to less than 49 is 5 to 30 wt.-%, more preferred of 10 to 25 wt.-%.

On the other hand it is preferred that the terpolymer of the present technology is in particular characterized by a broad compositional spread, i.e. the terpolymer has wide spread in isotactic sequence length “s”. Such a wide spread guarantees that on the one hand the gas permeability of a film based on said terpolymer is rather low and that on the other hand the terpolymer can easily be processed into a metallised biaxially oriented polypropylene film. Thus it is preferred that the terpolymer comprises additionally at least 5 wt.-%, more preferred at least 8 wt.-%, yet more preferred at least 10 wt.-%, still more preferred at least 12 wt.-%, of a crystalline fraction with an isotactic sequence length “s” of below 18. On the other hand the fraction should be not to big otherwise the barrier properties are negatively influenced. Thus it is preferred that the crystalline fraction with an isotactic sequence length “s” of below 18 is not more than 22 wt.-%, still more preferred not more than 20 wt.-%, yet more preferred not more than 18 wt.-%. A preferred range for the crystalline fraction with an isotactic sequence length “s” of below 18 is 5 to 20 wt.-%, more preferred of 10 to 18 wt.-%.

Of course it is appreciated that the terpolymer of the present technology has not only crystalline fractions with a rather long isotactic sequence length “s”, i.e. of more than 34 to less than 49, and a rather short isotactic sequence length “s”, i.e. of below 18, but comprises also fractions with an isotactic sequence length falling in-between the two extremes (see FIG. 1).

Thus the following amounts for the fractions with an isotactic sequence length “s” of 18 to 21, 21 to 26, and 26 to 34 are preferred.

A preferred range for the crystalline fraction with an isotactic sequence length “s” of 18 to 21 is 5 to 20 wt.-%, more preferred of 8 to 15 wt.-%.

A preferred range for the crystalline fraction with an isotactic sequence length “s” of 21 to 26 is 15 to 30 wt.-%, more preferred of 20 to 26 wt.-%.

A preferred range for the crystalline fraction with an isotactic sequence length “s” of 26 to 34 is 20 to 35 wt.-%, more preferred of 25 to 32 wt.-%.

High melting temperatures ensure a good extrusion lamination of multilayer films. Accordingly the terpolymer according to the present technology has preferably a rather high melting temperature, i.e. higher than 140° C. Thus it is even more preferred that the melting temperature is at least 143° C., still more preferred at least 145° C. On the other hand the melting temperature should be not too high. Therefore it is preferred that the melting temperature is not higher than 158° C., still more preferred not higher than 155° C. and yet more preferred not higher than 153° C. Preferably the melting temperature is in the range of 141 to 157° C., more preferably in the range of 142 to 155° C., still more preferably in the range of 145 to 152° C., and yet more preferably in the range of 145 to 151° C.

The Vicat softening temperature, like Vicat A50 at 10 N, reflects the heat softening characteristic of polymers. For the measurement a flat specimen is placed in a temperature regulated heating bath, a flat-ended needle is set on the specimen surface under a specific load and the bath temperature is raised at a constant rate. The temperature of the bath at which the penetration of the needle has reached a predefined level is the Vicat A50 at 10 N softening temperature according to ISO 306. The exact measuring method is determined in the example section.

Accordingly the Vicat A50 temperature at 10 N is an appropriate parameter to define the terpolymer of the present technology with regard to its thermal behaviour. A higher Vicat A50 temperature at 10 N means a better thermal resistance of a surface. Thus it is appreciated that the terpolymer of the present technology leads to a high Vicat A50 temperature at 10 N when formed into a film.

Accordingly the terpolymer of the present technology has preferably a heat resistance measured according to ISO 306 Vicat A50 at 10 N of at least 127° C., more preferably of more than 129° C. and yet more preferably of more than 131° C.

According to a third aspect of the present technology a terpolymer of propylene, ethylene and a C₄ to C8 α-olefin is provided, wherein:

a) the amount of propylene in said terpolymer is at least 94 wt.-%; and

b) said terpolymer has a heat resistance measured according to ISO 306 Vicat A50 at 10 N of at least 127° C.

Preferably the terpolymer has been produced in the presence of a Ziegler-Natta catalyst.

Preferably propylene, ethylene and a C₄ to C₈ α-olefin are the only monomers of the terpolymer of the present technology. The C₄ to C₈ α-olefin can be any α-olefin, i.e. branched and linear α-olefin, like 1-butene, 1-pentene, 4-methyl-1-pentene, 1-hexene, 1-heptene or 1-octene, however 1-butene is preferred.

Surprisingly, it has been found that a terpolymer with such features has superior properties compared to known terpolymers in this technical field. The terpolymer is in particular characterized to be less sensitive to surfaces defects during the processing of biaxially oriented polypropylene films and less sensitive to surface crazing during the manipulation of said films, like in metalizing said films. Achieved are these beneficial properties by a rather high heat resistance of the terpolymer and by a rather low content of the remaining comonomers, i.e. of ethylene and C₄ to C₈ α-olefin, preferably 1-butene, present in the terpolymer. Moreover the terpolymer has improved barrier properties which further widen the applications of the terpolymer of the present technology.

The terpolymer of the present technology has a rather a high content of propylene in the terpolymer, i.e. higher than 94 wt.-%. A rather high amount of propylene in the terpolymer indicates on the other hand rather low amounts of the other remaining comonomers, namely of ethylene and C₄ to C₈ α-olefin. Such a ratio of propylene to the other comonomers improves the crystallinity properties and improves additionally the barrier properties. Thus it is preferred that the propylene content in the terpolymer is at least 95 wt.-%, more preferred at least 96 wt.-% and yet more preferred at least 96.5 wt.-%.

As stated above not only the propylene content in the polymer is rather high but also the content of ethylene is rather low. A rather low amount of ethylene is beneficial for gas barrier properties of films produced from the polymer. Accordingly it is preferred that the ethylene content in the terpolymer is not more than 1.5 wt.-%, yet more preferred not more than 1.0 wt.-%. On the other hand ethylene is present in the terpolymer to reduce the surface brittleness to avoid surface cracking during film manipulation. Thus ethylene is at least detectable as defined below. However it is preferred that the ethylene content is at least 0.2 wt.-%, more preferred at least 0.3 wt.-%, still more preferred at least 0.4 wt.-%, and yet more preferred at least 0.5 wt.-%. A preferred range of ethylene in the terpolymer is 0.1 to 1.5 wt.-%, more preferred 0.3 to 1.2 wt.-%, yet more preferred 0.5 to 1.0 wt.-%.

For the C₄ to C₈ α-olefin, in particular 1-butene, applies similar considerations as for ethylene. Accordingly the content of C₄ to C₈ α-olefin, preferably 1-butene, in the terpolymer is rather low. A rather low amount of C₄ to C₈ α-olefin, preferably 1-butene, ensures a high melting temperature. Accordingly it is preferred that the content of C₄ to C₈ α-olefin, preferably 1-butene, in the terpolymer is below 4.0 wt.-%, more preferably below 3.5 wt.-% and yet more preferably not more than 3.0 wt.-%. On the other hand C₄ to C₈ α-olefin, preferably 1-butene, is present in the terpolymer to guarantee good processing properties and good metal adhesion. Thus C₄ to C₈ α-olefin, preferably 1-butene, is at least detectable as defined below. However it is preferred that the content of C₄ to C₈ α-olefin, preferably 1-butene, is at least 1.0 wt.-%, more preferred at least 1.3 wt.-%, still more preferred at least 1.6 wt.-%, and yet more preferred at least 2.0 wt.-%. A preferred range of the C₄ to C₈ α-olefin, in particular 1-butene, in the terpolymer is 1.0 to 3.5 wt.-%, more preferred 1.5 to 3.2 wt.-%, yet more preferred 2.0 to 3.0 wt.-%.

The comonomer content, i.e. the content of propylene, ethylene and of C₄ to C₈ α-olefin, preferably 1-butene, can be determined with FT infrared spectroscopy, as described below in

A further condition of the present technology is that the terpolymer has a rather high softening temperature.

The Vicat softening temperature, like Vicat A50 at 10 N, reflects the heat softening characteristic of polymers. For the measurement a flat specimen is placed in a temperature regulated heating bath, a flat-ended needle is set on the specimen surface under a specific load and the bath temperature is raised at a constant rate. The temperature of the bath at which the penetration of the needle has reached a predefined level is the Vicat A50 at 10 N softening temperature according to ISO 306. The exact measuring method is determined in the example section.

Accordingly the Vicat A50 temperature at 10 N is an appropriate parameter to define the terpolymer of the present technology with regard to its thermal behaviour. A higher Vicat A50 temperature at 10 N means a better thermal resistance of a surface. Thus it is appreciated that the terpolymer of the present technology leads to a high Vicat A50 temperature at 10 N when formed into a film.

Accordingly the terpolymer of the present technology has a heat resistance measured according to ISO 306 Vicat A50 at 10 N of at least 127° C., preferably of more than 129° C. and

Like a high softening temperature also a high melting temperature ensures a good extrusion lamination of polymers. Accordingly it the terpolymer according to the present technology has preferably a rather high melting temperature, i.e. higher than 140° C. Thus it is even more preferred that the melting temperature is at least 143° C., still more preferred at least 145° C. On the other hand the melting temperature should be not too high. Therefore it is preferred that the melting temperature is not higher than 158° C., still more preferred not higher than 155° C. and yet more preferred not higher than 153° C. Preferably the melting temperature is in the range of 141 to 157° C., more preferably in the range of 142 to 155° C., still more preferably in the range of 145 to 151° C., and yet more preferably in the range of 145 to 151° C.

The stepwise isothermal segregation technique (SIST) provides a possibility to determine the lamellar thickness distribution and therewith the isotactic sequence length distribution of the terpolymer of the present technology. A significant amount of rather long isotactic sequence length “s” in the terpolymer improves the barrier properties of the same. Thus it is preferred that the terpolymer of the present technology comprises at least 5 wt-%, still more preferred at least 7 wt-%, yet more preferred at least 8 wt-%, still more preferred at least 10 wt-%, of a crystalline fraction with an isotactic sequence length “s” of more than 34 to less than 49, wherein said fraction is determined by stepwise isothermal segregation technique (SIST) as defined in the example section. In turn it an upper limit of this fraction is appreciated. Accordingly it is preferred that the crystalline fraction with an isotactic sequence length “s” of more than 34 to less than 49 is below 30 wt.-%, more preferred below 25 wt.-%. A preferred range for the crystalline fraction with an isotactic sequence length “s” of more than 34 to less than 49 is 5 to 30 wt.-%, more preferred of 10 to 25 wt.-%.

On the other hand it is preferred that the terpolymer of the present technology is in particular characterized by a broad compositional spread, i.e. the terpolymer has wide spread in isotactic sequence length “s”. Such a wide spread guarantees that on the one hand the gas permeability of a film based on said terpolymer is rather low and that on the other hand the terpolymer can easily be processed into a metallised biaxially oriented polypropylene film. Thus it is preferred that the terpolymer comprises additionally at least 5 wt.-%, more preferred at least 8 wt.-%, yet more preferred at least 10 wt.-%, still more preferred at least 12 wt.-%, of a crystalline fraction with an isotactic sequence length “s” of below 18. On the other hand the fraction should be not to big otherwise the barrier properties are negatively influenced. Thus it is preferred that the crystalline fraction with an isotactic sequence length “s” of below 18 is not more than 22 wt.-%, still more preferred not more than 20 wt.-%, yet more preferred not more than 18 wt.-%. A preferred range for the crystalline fraction with an isotactic sequence length “s” of below 18 is 5 to 20 wt.-%, more preferred of 10 to 18 wt.-%.

Of course it is preferred that the terpolymer of the present technology has not only crystalline fractions with a rather long isotactic sequence length “s”, i.e. of more than 34 to less than 49, and a rather short isotactic sequence length “s”, i.e. of below 18, but comprises also fractions with an isotactic sequence length falling in-between the two extremes (see FIG. 1).

Thus the following amounts for the fractions with an isotactic sequence length “s” of 18 to 21, 21 to 26, and 26 to 34 are preferred.

A preferred range for the crystalline fraction with an isotactic sequence length “s” of 18 to 21 is 5 to 20 wt.-%, more preferred of 8 to 15 wt.-%.

A preferred range for the crystalline fraction with an isotactic sequence length “s” of 21 to 26 is 15 to 30 wt.-%, more preferred of 20 to 26 wt.-%.

A preferred range for the crystalline fraction with an isotactic sequence length “s” of 26 to 34 is 20 to 35 wt.-%, more preferred of 25 to 32 wt.-%.

The further features mentioned below apply to all embodiments described above, i.e. the first, the second and the third embodiment as defined above.

The heat sealing initiation temperature (SIT) of the terpolymer of the present technology is preferably in the range of 120 to 140° C., more preferably in the range of 125 to 135° C. For determining the heat sealing initiation temperature it is referred to the example section.

Furthermore, it is preferred that the terpolymer has a melt flow rate (MFR) given in a specific range. The melt flow rate mainly depends on the average molecular weight. This is due to the fact that long molecules render the material a lower flow tendency than short molecules. An increase in molecular weight means a decrease in the MFR-value. The melt flow rate (MFR) is measured in g/10 min of the polymer discharged through a defined dye under specified temperature and pressure conditions and the measure of viscosity of the polymer which, in turn, for each type of polymer is mainly influenced by its molecular weight but also by its degree of branching. The melt flow rate measured under a load of 2.16 kg at 230° C. (ISO 1133) is denoted as MFR₂. Accordingly, it is preferred that in the present technology the terpolymer has an MFR₂ in a range of 0.10 to 50.00 g/10 min, more preferably of 0.50 to 30.00 g/10 min, still more preferred of 1.00 to 20 g/10 min. In a preferred embodiment, the MFR₂ is in a range of 3.00 to 10.00 g/10 min. In another preferred embodiment the MFR₂ is about 6.00 g/10 min.

It is in addition preferred that the terpolymer of the present technology is further characterized by low amounts of extractables. Extractables are undesirable in the field of food packaging or in the field of medical packaging. However the terpolymer of the present technology is preferably used for such applications. Thus it is preferred that the terpolymer of the present technology has good processing properties even though said terpolymer is characterized by rather low amounts of xylene solubles and/or hexane solubles.

Xylene solubles are the part of the polymer soluble in cold xylene determined by dissolution in boiling xylene and letting the insoluble part crystallize from the cooling solution (for the method see below in the experimental part). The xylene solubles fraction contains polymer chains of low stereo-regularity and is an indication for the amount of non-crystalline areas.

Thus it is preferred that the terpolymer of the present technology has xylene solubles less than 10.00 wt.-%, more preferably less than 6.00 wt.-%.

Similar to xylene solubles the hexane solubles indicate that part of a polymer which has a low isotacticity and crytallinity and which is soluble in hexane at the boiling point.

Accordingly it is preferred that the terpolymer of the present technology has hexane solubles less than 4.00 wt.-%, more preferably less than 2.50 wt.-%.

The flexural modulus is the ratio, within the elastic limit, of the applied stress on a test specimen in flexure, to the corresponding strain in the outermost fibers of the specimen. The fexurual modulus of the present technology has been determined according to ISO 178.

Preferably, the terpolymer has a fexurual modulus of at least 950 MPa, more preferably of at least 980 MPa, yet more preferably of at least 1040 MPa.

In addition it is preferred that the terpolymer as defined above (and further defined below) is preferably multimodal, more preferably bimodal.

“Multimodal” or “multimodal distribution” describes a distribution that has several relative maxima (contrary to unimodal having only one maximum). In particular, the expression “modality of a polymer” refers to the form of its molecular weight distribution (MWD) curve, i.e. the appearance of the graph of the polymer weight fraction as a function of its molecular weight. If the polymer is produced in the sequential step process, i.e. by utilizing reactors coupled in series, and using different conditions in each reactor, the different polymer fractions produced in the different reactors each have their own molecular weight distribution which may considerably differ from one another. The molecular weight distribution curve of the resulting final polymer can be seen at a super-imposing of the molecular weight distribution curves of the polymer fractions which will, accordingly, show a more distinct maxima, or at least be distinctively broadened compared with the curves for individual fractions.

A polymer showing such molecular weight distribution curve is called bimodal or multimodal, respectively. The multimodal, preferably bimodal, terpolymer is in particular achieved by the process defined below.

In the following the preferred process is described to obtain the terpolymer of the present technology. Preferably the terpolymer is produced in a combination of one or more bulk polymerisation reactor(s) and one or more gas phase reactor(s).

However any other process is suitable as long as the terpolymer of the present technology is obtained.

According to the process as described herein, a process has been designed for producing a terpolymer as defined in the present technology in at least one slurry reactor in the presence of Ziegler-Natta catalyst(s) at elevated temperature. The process is in particular characterized by a feed gradient of ethylene and/or C₄ to C₈ α-olefin (preferably 1-butene), i.e. the amount of ethylene and/or C₄ to C₈ α-olefin fed into the process decreases over the time. The process comprises preferably the following steps:

a) feeding into a slurry reactor system, more preferably into a two slurry reactors system, a reaction mixture containing at least 79.5 wt.-% of propylene, 0.5 to 2.0 wt.-%, more preferably about 1.5 wt.-%, of ethylene, 20.0 to 5.0 wt-%, more preferably about 16.5 wt.-%, of a C₄ to C₈ α-olefin (preferably 1-butene), a Ziegler-Natta catalyst system capable of achieving olefin polymerization, and optionally hydrogen,

b) polymerizing said reaction mixture at a temperature of less than 70° C. but more than 60° C. for a average residence time of the comonomers in the slurry reactor system of 1 to 3 hours, preferably 2 hours to obtain a propylene terpolymer amounting to 80 to 100 wt.-%, more preferably 90 to 99 wt.-%, of the end terpolymer product, wherein the ethylene and/or C₄ to C₈ α-olefin (preferably 1-butene) concentrations in the feed to the slurry reactor system decrease over a time period of 6 to 9 hours, and at the end of the polymerisation step the ethylene concentration in the feed to the slurry reactor system is in the range of 0.2 to 0.4 wt.-%, more preferably about 0.3 wt.-%, and the C₄ to C₈ α-olefin (preferably 1-butene) concentration in the feed to the slurry reactor system is in the range of 1.0 to 2.5 wt-%, more preferably about 2.0 wt.-%, to obtain the end terpolymer product (in case all of the terpolymer is produced in step b), wherein the ethylene content is not more than 1.5 wt.-%, preferably is in the range of 0.1 to 1.3 wt.-%, more preferably is in the range of 0.5 to 1.0 wt.-%, still more preferably is about 0.4 wt.-% and the C₄ to C₈ α-olefin (preferably 1-butene) content is not more than 4.0 wt.-%, preferably is in the range of 1.0 to 3.5 wt.-%, more preferably is in the range of 2.0 to 3.0 wt.-%,

c) transferring said reaction mixture into a gas phase reactor operating at a pressure higher than 5 bar, preferably higher than 10 bar, without adding ethylene, C₄ to C₈ α-olefin (preferably 1-butene) and hydrogen, and

d) continuing polymerization in said gas phase reactor, wherein the amount of the ethylene and/or C₄ to C₈ α-olefin (preferably 1-butene) decreases during the polymerization over the time, for obtaining a propylene terpolymer amounting to 0 to 20 wt.-%, more preferably I to 10 wt.-%, of the end terpolymer product, wherein the final terpolymer is characterized as defined in the present technology.

Thus, according to the present technology, the terpolymerization is carried out in a slurry phase, preferably in a loop reactor system, more preferably in a two loop reactors system, by using relatively low amounts of ethylene and of C₄ to C₈ α-olefin (preferably 1-butene) as comonomers. Moreover the process is characterized by a feed gradient over the polymerization time of at least one of the two comonomers, i.e. ethylene and/or of C₄ to C₈ α-olefin (preferably 1-butene). More preferably during the production of the terpolymer of the present technology the ethylene and the C₄ to C₈ α-olefin (preferably 1-butene) content is gradually decreased resulting in a broad comonomer distribution providing benefits in BOPP processing. As stated above it is preferred that at the starting point (step a)) the ethylene feed is about 1.5 wt.-% and the C₄ to C₈ α-olefin (preferably 1-butene) feed is about 16.5 wt.-%. During the processing in step b) the ethylene and the C₄ to C₈ α-olefin (preferably 1-butene) content in the powder is decreased by lowering the ethylene and the C₄ to C₈ α-olefin (preferably 1-butene) concentration in the feed to the slurry reactor, preferably to the loop reactor, more preferably to the two loop reactors. This is done gradually over the time, the speed of reduction depends on the lot size. Ethylene is preferably decreased as stated above from about 1.5 wt.-% to about 0.3 wt.-% in the first half of the lot and kept preferably constant for the second part of the lot. The C₄ to C₈ α-olefin (preferably 1-butene) is preferably lowered to 2.0 wt.-%. The melt flow of the powder is preferably kept constant by adjusting the hydrogen to the slurry reactor, more preferably to the loop reactor, still more preferably to the two loop reactors, according the comonomer concentration in the feed to the said reactor(s). The reaction temperature is preferably about 63° C.

The C₄ to C₈ α-olefin can be preferably 1-butene, 1-pentene, 4-methyl-1-pentene, 1-hexene, 1-heptene or 1-octene. However 1-butene is the most preferred C₄ to C₈ (x-olefin.

As catalyst any ordinary stereospecific Ziegler-Natta catalysts can be used. An essential component in those catalysts are solid catalyst components comprising a titanium component having at least one titanium-halogen bond, an electron donor compound and a magnesium halide in active form. The catalysts can contain as an internal electron donor compound compounds selected from ethers, ketones, lactones, compounds containing N, P and/or S atoms and esters of mono and dicarboxylic acids.

Polymerization in step b) can be carried out in the presence of an organoaluminium compound, such as an aluminium alkyl and an optional external donor compound at temperatures lower than 70° C. but more than 60 C, preferably at a temperature about 63° C., and pressures in the range of 30 to 90 bar, preferably 30 to 70 bar. The polymerization is carried out in such conditions that 80 to 100 wt.-%, preferably 90 to 99 wt.-% of the end product is polymerized in the slurry reactor or reactors. The residence time in the slurry reactor system can be between 60 and 180 min.

After the polymerization is complete in the slurry reactor, the reaction medium is not separated from the polymer particles in a conventional flash tank. Instead, the whole content of the polymerization medium along with the polymer particles are transferred into a gas phase reactor, if necessary.

In the gas phase reactor, 1 to 20 wt.-%, preferably 1 to 10 wt.-% of the final end terpolymer product is formed. The polymerization can be carried out at a temperature of 60 to 90° C. and at a pressure higher than 5 bar, preferably higher than 10 bar. No comonomers and hydrogen are added into the gas phase reactor.

The liquid medium from the first stage reactor can function as a cooling medium of the fluid bed in the gas phase reactor, when evaporating therein.

The amount of C₄ to C₈ α-olefin (preferably 1-butene) after the gas phase polymerisation (step d)) is preferably in the range of 0.1 to 4.0 wt.-%, more preferably in the range of 2.0 to 3.5 wt.-%. The amount of propylene in the final terpolymer (after step d)) is at least 94 wt.-%, more preferably at least 95 wt.-%. Finally the amount of ethylene in the terpolymer after the gas phase polymerization (step d)) can be 0.1 to 1.5 wt.-%, more preferably 0.5 to 1.0 wt.-%. Thus the content of C₄ to C₈ α-olefin such as 1-butene is very low. The same applies for the ethylene content in the terpolymer of the present technology.

The present technology is not only related to the terpolymer of the present technology itself but also to its use and to films and/or articles comprising the terpolymer of the present technology. Accordingly the terpolymer of the present technology as defined above is used for films, preferably for biaxially oriented multilayer films, more preferably for metallised biaxially oriented multilayer films. Even more preferred the terpolymer is used in the packaging industry, i.e. for packaging materials, i.e. food packaging materials. Moreover the presented technology is directed to films, preferably to biaxially oriented multilayer films, more preferably to metallised biaxially oriented multilayer films comprising the terpolymer of the present technology as defined above. More precisely and preferably the metallised biaxially oriented multilayer film comprises:

a) a core layer comprising preferably a high crystallinity polypropylene homopolymer, more preferably a high crystallinity polypropylene homopolymer with a stereoregularity greater than 93%;

(b) a first skin layer adjacent to said core layer wherein said skin layer comprises the terpolymer of the present technology, more preferably is the terpolymer of the present technology;

(c) optionally a tie layer adjacent to said first skin layer comprising preferably maleic anhydride modified polypropylene homopolymer or copolymer;

(d) a metalized layer, preferably a aluminium layer, adjacent to said first skin or optionally first tie layer and on a side of the skin or optionally first tie layer opposite the core layer; and

(e) optionally a second skin layer adjacent to said core layer and on a side of said core layer opposite said first skin layer, said second skin layer comprising preferably a polyolefin selected from the group consisting of ethylene-propylene random copolymer, ethylene-propylene-butylene terpolymer, propylene-butylene copolymer, and ethylene-propylene impact copolymer.

Moreover the present technology is directed to articles comprising the terpolymer of the present technology as defined above. In a preferred aspect the articles comprising the terpolymer of the present technology, preferably as part of a biaxially oriented multilayer film, more preferably as a part of metallised biaxially oriented multilayer film as defined above, are selected from the group of packaging material, food packaging material (in particular for coffee, potato chips and/or cookies), foils and wrapping material.

The biaxially oriented multilayer films, preferably the present metallised biaxially oriented multilayer films, comprising the terpolymer can be produced by known manner in the art. One method of making the above-described (metallised) biaxially oriented multilayer film comprises coextruding a multilayer melt of thermoplastic polymers through a die, then cooling, e. g., by quenching, the multilayer melt to form a multilayer sheet. The multilayer sheet is then stretched in the machine direction (MD) over a series of heated rollers travelling at a differential speed to form an MD oriented multilayer film. The stretching of the MD oriented multilayer film takes place in a heated tenter frame to form a biaxially oriented multilayer film. Surface treating is then performed on the first skin layer and/or the second skin layer of the biaxially oriented multilayer film with a treatment selected from the group consisting of corona treatment, flame treatment and plasma treatment. Then the first skin layer is preferably metalized in a vacuum metalizer to form the desired metalized biaxially oriented multilayer film.

The present technology will now be described in further detail by the examples provided below.

### EXAMPLES

### 1. Definitions/Measuring Methods

The following definitions of terms and determination methods apply for the above general description of the present technology as well as to the below examples unless otherwise defined.

### A. NMR-Spectroscopy Measurements

The ¹³C-NMR spectra of polypropylenes were recorded on Bruker 400 MHz spectrometer at 130° C. from samples dissolved in 1,2,4-trichlorobenzene/benzene-d6 (90/10 w/w). For the pentad analysis the assignment is done according to the methods described in literature: (T. Hayashi, Y. Inoue, R. Chüjö, and T. Asakura, Polymer 29 138-43 (1988).and Chujo R, et al, Polymer 35 339 (1994).

### B. Differential Scanning Calorimetry (DSC)

Melting temperature Tm, crystallization temperature Tc, and the degree of crystallinity are measured with Mettler TA820 differential scanning calorimetry (DSC) on 5-10 mg samples. Both crystallization and melting curves were obtained during 10° C./min cooling and heating scans between 30° C. and 225° C. Melting and crystallization temperatures were taken as the peaks of endotherms and exotherms.

Also the melt- and crystallization enthalpy (Hm and Hc) were measured by the DSC method according to ISO 11357-3. In case more than one melting peak is observed, the melting temperature Tm (as used to interpret the SIST data) is the maximum of the peak at the highest melting temperature with an area under the curve (melting enthalpy) of at least 5% of the total melting enthalpy of the crystalline fraction of the polypropylene.

### C. Melt Flow Rate

MFR₂ is measured according to ISO 1133 (230° C., 2.16 kg load).

### D. Comonomer Content

The comonomer content is measured with Fourier transform infrared spectroscopy (FTIR) calibrated with ¹³C-NMR. When measuring the ethylene content in polypropylene, a thin film of the sample (thickness about 250 μm) was prepared by hot-pressing. The area of —CH₂— absorption peak (710-750 cm⁻¹) and of the buteen absorption peak (750 -780cm⁻¹) was measured with Perkin Elmer FTIR 1600 spectrometer. The method was calibrated by ethylene content and 1-butene content data measured by ¹³C-NMR.

### E. Stiffness of the Film

Stiffness Film TD (transversal direction), Stiffness Film MD (machine direction), Elongation at break TD and Elongation at break MD are determined according to ISO 527-3 (cross head speed: 1 mm/min).

### F. Flexural Modulus

Flexural Modulus is measured according to ISO 178.

### G. Haze and Transparency

Haze and transparency are determined: ASTM D1003-92.

### H. Stepwise Isothermal Segregation Technique (SIST)

The isothermal crystallisation for SIST analysis was performed in a Mettler TA820 DSC on 5±0.5 mg samples at decreasing temperatures between 200° C. and 105° C.
(i) The terpolymer samples were melted at 225° C. for 5 min.,
(ii) then cooled with 60° C./min to 145° C.
(iii) held for 2 hours at 145° C.,
(iv) then cooled with 60° C./min to 135° C.
(v) held for 2 hours at 135° C.,
(vi) then cooled with 60° C./min to 125° C.
(vii) held for 2 hours at 125° C.,
(viii) then cooled with 60° C./min to 115° C.
(ix) held for 2 hours at 115° C.,
(x) then cooled with 60° C./min to 105° C.
(xi) held for 2 hours at 105° C.
(xii) then cooled down with 60° C./min to 20° C. and
(xiii) then heated at a heating rate of 10° C./min up to 200° C. obtaining a melting curve of said cooled terpolymer samples, wherein:
said melting curve is used:

(a) to calculate in a first step the lamella thickness distribution according to Thomson-Gibbs equation (Eq 1.)

$${T}_{m} = {T}_{0} ( 1 - \frac{2 σ}{Δ {H}_{0} \cdot L} ) \qquad ( 1 )$$

wherein:

T₀=457 K,

ΔH₀=184×10⁶ J/m³,

σ=0.0496 J/m²,

Tₘ is the measured temperature (K),

L is the lamella thickness (nm) and

(b) to calculate in a second step the isotactic sequence length “s” using the equation (Eq 2.)

s=L/(0.65·3) (2)

wherein:

s is the isotactic sequence length and

L is the lamella thickness.

The average isotactic sequence length is calculated from lamella thickness using a fibre length of 6.5 Å for the 3/1 helices of polypropylene (Monoclinic α-form, c-axis).

All measurements were performed in a nitrogen atmosphere. The melt enthalpy is recorded as a function of temperature and evaluated through measuring the melt enthalpy of fractions melting within temperature intervals of 10° C.

### I. Heat Sealing Initiation Temperature (SIT):

### 1. General

The method determines the sealing temperature range of polypropylene films, in particular blown films. The sealing temperature range is the temperature range, in which the films can be sealed according to conditions given below.

The lower limit (heat sealing initiation temperature (SIT)) is the sealing temperature at which a sealing strength of >3 N is achieved. The upper limit (sealing end temperature (SET)) is reached, when the films stick to the sealing device.

### 2. Testing

### Determined on J&B Universal Sealing Machine Type 3000

Measured on a film—specimen width: 25.4 mm

### Seal Pressure: 0.1 N/mm

### Seal Time: 0.1 sec

Cool time: 99 sec
Peel Speed: 10 mm/sec
Start temperature: 80° C.
End temperature: 150° C.
Increments: 10° C.—specimen is sealed A to A at each sealbar temperature and seal strength (force) is determined at each step.

The temperature is determined at which the seal strength reaches 3 N.

### J. Xylene Solubles (XS, wt.-%)

2 g of polymer is added to 200 ml xylene in a reflux vessel with N₂ purge.

The mixture is heated up to 135° C. in 35 minutes and stirred for 30 minutes (meanwhile the polymer is dissolved in boiling xylene).

Then the sample is cooled to 50° C. in 30 minutes and when reaching 50° C. the solution is placed in a water-bath at 25° C. and keeping it in the water-bath for exact 140 minutes without stirring.

Then the mixture is stirred for exact 10 minutes.

The mixture is filtered. The precipitate is dried in a vacuum-oven at 70° C. during 30 minutes.

XS%=(100×m₁×v₀)/(m₀×v₁), wherein
m₀initial polymer amount (g)
m₁=weight of residue (g)
v₀=initial volume (ml)
V₁=volume of analyzed sample (ml)

### K. Hexane Solubles (wt.-%)

FDA section 177.1520

During 2 hours 1 g of a polymer film of 100 μm thickness is added to 400 ml hexane and is boiled while stirring with a reflux cooler.

After 2 hours the mixture is immediately filtered on a filter paper N° 41.

The precipitate is collected in an aluminium recipient and the residual hexane is evaporated on a steam bath under N₂ flow.

The amount of hexane solubles is determined by the formula

((wt. sample+wt. crucible)−(wt crucible))/(wt. sample)·100.

### L. Vicat A50

Vicat A50 at 10 N is measured according to ISO 306 (10 N). Viact A50 is the temperature at which the specimen is penetrated to a depth of 1 mm by a flat-ended needle with a 1 sq. mm circular or square cross-section, under a 1000-gm load.

### M. Isothermal Crystallisation Speed

ISO 11357-7 (2002)

### 2. EXAMPLES

### Example 1 (Inventive 1)

The reaction is done in a two loop reactor system and a gas phase reactor without any additional comonomer feed. During the production of the polymer, the 1-butene and ethylene content of the powder is gradually decreased. The 1-butene and ethylene content in the powder is decreased by lowering the 1-butene and ethylene concentration in the feed to the loop reactors. This is done gradually over a time period of 9 hours. 1-butene concentration in the feed is lowered from 6.5 wt.-% to 0.5 wt.-%. Ethylene concentration in the feed is kept constant at 1.0 wt %. The melt flow of the powder is kept constant by adjusting the hydrogen feed to the loops according to the 1-butene concentration in the feed to the loop reactors. The reaction temperature in the loop reactor system is 63° C.

### Example 2 (Inventive 2)

The reaction is done in a two loop reactor system and a gas phase reactor without any additional comonomer feed. During the production of the polymer, the 1-butene and ethylene content of the powder is gradually decreased. The 1-butene and ethylene content in the powder is decreased by lowering the 1-butene and ethylene concentration in the feed to the loop reactors. This is done gradually over a time period of 7.5 hours. 1-butene concentration in the feed is lowered from 16.5 wt.-% to 1.0 wt.-%. Ethylene concentration in the feed is decreased from 1.0 wt % to 0.3 wt % in the first half of the lot and kept constant for the second part of the lot. The melt flow of the powder is kept constant by adjusting the hydrogen feed to the loops according to 1-butene concentration in the feed to the loop reactors. The loop reactor system temperature is 63° C.

### Example 3 (Comparison 1)

Same process as for production of polymer 1, but 1-butene and ethylene feed are constant (16.4 wt.-% 1-butene and 1.0 wt.-% ethylene in the feed to the reactors) to obtain a polymer with 9.0 wt.-% 1-butene and 1.0 wt.-% ethylene. Reactor temperature is 63° C.

### Example 4 (Comparison 2)

Same process settings as for production of polymer 1, but 1-butene and ethylene feed are constant (13.3 wt.-% 1-butene and 0.3 wt.-% ethylene in the feed to the reactors) to obtain a polymer with 8.0 wt.-% 1-butene and 0.3 wt.-% ethylene. Reactor temperature is 65° C.

TABLE 1
Properties of the Examples

| | | Example 1 | Example 2 | Example 3 | Example 4 |
|---|---|---|---|---|---|
| | | [Inven- | [Inven- | [Compar- | [Compar- |
| | | tive] | tive] | ison] | ison] |
| C2-content | wt.-% | 1.0 | 0.6 | 1.0 | 0.3 |
| C4-content | wt.-% | 2.0 | 2.5 | 9.0 | 8.0 |
| Xylene | wt.-% | 3.9 | 4.1 | 5.1 | 4.1 |
| Solubles | | | | | |
| Hexane | wt.-% | 2.2 | 1.9 | 2.6 | — |
| Solubles | | | | | |
| MFR₂ | g/10 | 7 | 7 | 6 | 8 |
| | min | | | | |
| Vicat A50 | ° C. | 135.7 | 131.1 | 115.8 | 125.6 |
| (10 N) | | | | | |
| Tₘₑₗₜ | ° C. | 149.4 | 144.1 | 130.4 | 138.7 |
| Hₘₑₗₜ | J/g | 92.8 | 93.3 | 76.5 | 78.8 |
| T_{cryst} | ° C. | 106 | 105 | 91 | 97.4 |
| H_{cryst} | J/g | 84 | 85 | 68.6 | 68.4 |
| Fraction <100° | % | 12.1 | 13.2 | 31.6 | 20.9 |
| C. | | | | | |
| Fraction <120° | % | 19.6 | 23.1 | 47.9 | 32.2 |
| C. | | | | | |
| Flex Mod | MPa | 1081 | 1045 | 761 | 937 |

TABLE 2
SIST-values

| | | Example 1 | Example 2 | Example 3 | Example 4 |
|---|---|---|---|---|---|
| s < 18 | % | 11.6 | 17.7 | 41.9 | 22.2 |
| 18 < s < 26 | % | 9.4 | 14.1 | 30.6 | 25.6 |
| 21 < s < 26 | % | 22.9 | 25.8 | 24.9 | 26.1 |
| 26 < s < 34 | % | 30.1 | 30.5 | 1.67 | 24.5 |
| 34 < s < 49 | % | 24.7 | 10.1 | 0.45 | 0.69 |

TABLE 3
Isothermal Crystallization Speed

| | | Example 1 | Example 2 | Example 3 | Example 4 |
|---|---|---|---|---|---|
| at 100° C. | min | 1.9 | 2 | 4 | 2.5 |
| at 105° C. | min | 2 | 2.2 | 7.4 | 3.2 |
| at 110° C. | min | 2.3 | 2.8 | NA | 5.8 |

The present technology has now been described in such full, clear, concise and exact terms as to enable a person familiar in the art to which it pertains, to practice the same. It is to be understood that the foregoing describes preferred embodiments and examples of the present technology and that modifications may be made therein without departing from the spirit or scope of the present technology as set forth in the claims. Moreover, while particular elements, embodiments and applications of the present technology have been shown and described, it will be understood, of course, that the present technology is not limited thereto since modifications can be made by those familiar in the art without departing from the scope of the present disclosure, particularly in light of the foregoing teachings and appended claims. Moreover, it is also understood that the embodiments shown in the drawings, if any, and as described above are merely for illustrative purposes and not intended to limit the scope of the present technology, which is defined by the following claims as interpreted according to the principles of patent law, including the Doctrine of Equivalents. Further, all references cited herein are incorporated in their entirety.

1. A terpolymer comprising propylene, ethylene and C₄ to C₈ α-olefin wherein:
a) the amount of propylene in said terpolymer is at least 94 percent by weight;
b) the melting temperature of said terpolymer is more than 140° C.; and
c) the terpolymer has been produced in the presence of a Ziegler-Natta catalyst.

2. The terpolymer of claim 1, wherein said terpolymer comprises at least 5 percent by weight of a crystalline fraction with an isotactic sequence length “s” between 34 and 49, wherein said fraction is determined by a stepwise isothermal segregation technique, wherein:
a) the terpolymer is melted at 225° C. for 5 min.;
b) then cooled at a rate of 60° C./min to 145° C.;
c) held for 2 hours at 145° C.;
d) then cooled at a rate of 60° C./min to 135° C.;
e) held for 2 hours at 135° C.;
f) then cooled at a rate of 60° C./min to 125° C.;
g) held for 2 hours at 125° C.;
h) then cooled at a rate of 60° C./min to 115° C.;
i) held for 2 hours at 115° C.;
j) then cooled at a rate of 60° C./min to 105° C.;
k) held for 2 hours at 105° C.;
l) then cooled at a rate of 60° C./min to 20° C.; and
m) then heated at a heating rate of 10° C./min up to 200° C. to obtain a melting curve of said cooled terpolymer, wherein said melting curve is used:
(i) to calculate, in a first step, the lamella thickness distribution according to the Thomson-Gibbs equation, recited as:
$${T}_{m} = {T}_{0} ( 1 - \frac{2 σ}{Δ {H}_{0} \cdot L} ) ;$$
wherein:
T₀=457 K;
ΔH₀=184×10⁶ J/m³;
σ=0.0496 J/m²;
Tₘ is the measured temperature (measured in degrees K); and
L is the lamella thickness (measured in nm); and
(ii) to calculate, in a second step, the isotactic sequence length using the following equation:
s=L/(0.65·3);
wherein:
s is the isotactic sequence length; and
L is the lamella thickness.

3. The terpolymer of claim 2, wherein said terpolymer has a heat resistance at least 127° C. measured according to ISO 306 Vicat A50 at 10 N.

4. The terpolymer of claim 1, wherein the melting temperature of said terpolymer is below 152° C.

5. The terpolymer of claim 4, wherein wherein the melting temperature of said terpolymer is approximately in the range of 145° C. to 152° C.

6. The terpolymer of claim 1, wherein the amount of ethylene is not more than 1.5 percent by weight in the terpolymer.

7. The terpolymer of claim 1, wherein the amount of C₄ to C₈ α-olefin is at least 1.5 percent by weight.

8. The terpolymer of claim 1, wherein the amount of C₄ to C₈ α-olefin is less than 4.0 percent by weight.

9. The terpolymer of claim 1, wherein the C₄ to C8 α-olefin is 1-butene.

10. The terpolymer of claim 1, wherein the terpolymer comprises 5 to 20 percent by weight of a crystalline fraction with an isotactic sequence length “s” of below 18, wherein said fraction is determined by a stepwise isothermal segregation technique, wherein:
a) the terpolymer is melted at 225° C. for 5 min.;
b) then cooled at a rate of 60° C./min to 145° C.;
c) held for 2 hours at 145° C.;
d) then cooled at a rate of 60° C./min to 135° C.;
e) held for 2 hours at 135° C.;
f) then cooled at a rate of 60° C./min to 125° C.;
g) held for 2 hours at 125° C.;
h) then cooled at a rate of 60° C./min to 115° C.;
i) held for 2 hours at 115° C.;
j) then cooled at a rate of 60° C./min to 105° C.;
k) held for 2 hours at 105° C.;
l) then cooled at a rate of 60° C./min to 20° C.; and
m) then heated at a heating rate of 10° C./min up to 200° C. to obtain a melting curve of said cooled terpolymer, wherein said melting curve is used:
(i) to calculate, in a first step, the lamella thickness distribution according to the Thomson-Gibbs equation, recited as:
$${T}_{m} = {T}_{0} ( 1 - \frac{2 σ}{Δ {H}_{0} \cdot L} ) ;$$
wherein:
T₀=457 K;
ΔH₀=184×10⁶ J/m³;
σ=0.0496 J/m²;
Tₘ is the measured temperature (measured in degrees K); and
L is the lamella thickness (measured in nm); and
(ii) to calculate, in a second step, the isotactic sequence length using the following equation:
s=L/(0.65·3);
wherein:
s is the isotactic sequence length; and
L is the lamella thickness.

11. The terpolymer of claim 1, wherein the terpolymer has xylene solubles of not more than 4.50 percent by weight.

12. The terpolymer of claim 1, wherein the terpolymer has hexane solubles of not more than 2.50 percent by weight.

13. The terpolymer of claim 1, wherein the terpolymer has a felexural modulus of at least 950 MPa, measured according to ISO 178.

14. A terpolymer comprising propylene, ethylene and C₄ to C₈ α-olefin wherein said terpolymer comprises at least 94 percent by weight propylene, and said terpolymer comprises at least 5 percent by weight of a crystalline fraction, said crystalline fraction having an isotactic sequence length (“s”) between 34 and 49, wherein said fraction is determined by a stepwise isothermal segregation technique, wherein:
a) the terpolymer is melted at 225° C. for 5 min.;
b) then cooled at a rate of 60° C./min to 145° C.;
c) held for 2 hours at 145° C.;
d) then cooled at a rate of 60° C./min to 135° C.;
e) held for 2 hours at 135° C.;
f) then cooled at a rate of 60° C./min to 125° C.;
g) held for 2 hours at 125° C.;
h) then cooled at a rate of 60° C./min to 115° C.;
i) held for 2 hours at 115° C.;
j) then cooled at a rate of 60° C./min to 105° C.;
k) held for 2 hours at 105° C.;
l) then cooled at a rate of 60° C./min to 20° C.; and
m) then heated at a heating rate of 10° C./min up to 200° C. to obtain a melting curve of said cooled terpolymer, wherein said melting curve is used:
(i) to calculate, in a first step, the lamella thickness distribution according to the Thomson-Gibbs equation, recited as:
$${T}_{m} = {T}_{0} ( 1 - \frac{2 σ}{Δ {H}_{0} \cdot L} ) ;$$
wherein:
T₀=457 K;
ΔH₀=184×10⁶ J/m³;
σ=0.0496 J/m²;
Tₘ is the measured temperature (measured in degrees K); and
L is the lamella thickness (measured in nm); and
(ii) to calculate, in a second step, the isotactic sequence length using the following equation:
s=L/(0.65·3);
wherein:
s is the isotactic sequence length; and
L is the lamella thickness.

15. The terpolymer of claim 14, wherein the terpolymer comprises at least one of the following properties:
a) the melting temperature of said terpolymer is more than 140° C., and
b) the heat resistance of the terpolymer is at least 127° C., measured according to ISO 306 Vicat A50 at 10 N.

16. A terpolymer comprising propylene, ethylene and C₄ to C₈ α-olefin, wherein the amount of propylene in said terpolymer is at least 94 percent by weight, and said terpolymer has a heat resistance of at least 127° C., measured according to ISO 306 Vicat A50 at 10 N.

17. The terpolymer of claim 16, wherein the terpolymer comprises at least one of the following properties:
a) the melting temperature of said terpolymer is more than 140° C., and
b) said terpolymer comprises at least 5 percent by weight of a crystalline fraction with an isotactic sequence length “s” of more than 34 to less than 49, wherein said fraction is determined by a stepwise isothermal segregation technique, wherein:
i) the terpolymer is melted at 225° C. for 5 min.;
ii) then cooled at a rate of 60° C./min to 145° C.;
iii) held for 2 hours at 145° C.;
iv) then cooled at a rate of 60° C./min to 135° C.;
v) held for 2 hours at 135° C.;
vi) then cooled at a rate of 60° C./min to 125° C.;
vii) held for 2 hours at 125° C.;
viii) then cooled at a rate of 60° C./min to 115° C.;
ix) held for 2 hours at 115° C.;
x) then cooled at a rate of 60° C./min to 105° C.;
xi) held for 2 hours at 105° C.;
xii) then cooled at a rate of 60° C./min to 20° C.; and
xiii) then heated at a heating rate of 10° C./min up to 200° C. to obtain a melting curve of said cooled terpolymer, wherein said melting curve is used:
(1) to calculate, in a first step, the lamella thickness distribution according to the Thomson-Gibbs equation, recited as:
$${T}_{m} = {T}_{0} ( 1 - \frac{2 σ}{Δ {H}_{0} \cdot L} ) ;$$
wherein:
T₀=457 K;
ΔH₀=184×10⁶ J/m³;
σ=0.0496 J/m²;
Tₘ is the measured temperature (measured in degrees K); and
L is the lamella thickness (measured in nm); and
(2) to calculate, in a second step, the isotactic sequence length using the following equation:
s=L/(0.65·3);
wherein:
s is the isotactic sequence length; and
L is the lamella thickness.

18. Film comprising a terpolymer, said terpolymer comprising propylene, ethylene and C₄ to C₈ α-olefin wherein:
a) the amount of propylene in said terpolymer is at least 94 percent by weight;
b) the melting temperature of said terpolymer is more than 140° C.; and
c) the terpolymer has been produced in the presence of a Ziegler-Natta catalyst.

19. The film of claim 18, wherein said terpolymer comprises at least 5 percent by weight of a crystalline fraction with an isotactic sequence length “s” between 34 and 49, wherein said fraction is determined by a stepwise isothermal segregation technique, wherein:
a) the terpolymer is melted at 225° C. for 5 min.;
b) then cooled at a rate of 60° C./min to 145° C.;
c) held for 2 hours at 145° C.;
d) then cooled at a rate of 60° C./min to 135° C.;
e) held for 2 hours at 135° C.;
f) then cooled at a rate of 60° C./min to 125° C.;
g) held for 2 hours at 125° C.;
h) then cooled at a rate of 60° C./min to 115° C.;
i) held for 2 hours at 115° C.;
j) then cooled at a rate of 60° C./min to 105° C.;
k) held for 2 hours at 105° C.;
l) then cooled at a rate of 60° C./min to 20° C.; and
m) then heated at a heating rate of 10° C./min up to 200° C. to obtain a melting curve of said cooled terpolymer, wherein said melting curve is used:
(i) to calculate, in a first step, the lamella thickness distribution according to the Thomson-Gibbs equation, recited as:
$${T}_{m} = {T}_{0} ( 1 - \frac{2 σ}{Δ {H}_{0} \cdot L} ) ;$$
wherein:
T₀=457 K;
ΔH₀=184×10⁶ J/m³;
σ=0.0496 J/m²;
Tₘ is the measured temperature (measured in degrees K); and
L is the lamella thickness (measured in nm); and
(ii) to calculate, in a second step, the isotactic sequence length using the following equation:
s=L/(0.65·3);
wherein:
s is the isotactic sequence length; and
L is the lamella thickness.

20. A biaxially oriented multilayer film comprising the film of claim 18.

21. The biaxially oriented multilayer film of claim 20, wherein said biaxially oriented multilayer film is me metallised.

22. A multilayer film comprising:
a) a core layer comprising a high crystallinity polypropylene homopolymer;
b) a first skin layer adjacent to said core layer wherein said skin layer comprises a terpolymer.

23. The multilayer film of claim 22, wherein the first skin layer is or comprises a terpolymer, said terpolymer comprising propylene, ethylene and C₄ to C₈ α-olefin wherein:
i) the amount of propylene in said terpolymer is at least 94 percent by weight;
ii) the melting temperature of said terpolymer is more than 140° C.; and
iii) the terpolymer has been produced in the presence of a Ziegler-Natta catalyst.

24. The multilayer film of claim 23, wherein the film further comprises at least one of the following:
(c) a tie layer adjacent to said first skin layer comprising preferably maleic anhydride modified polypropylene homopolymer or copolymer;
(d) a metalized layer adjacent to said first skin or first tie layer and on a side of the skin or first tie layer opposite the core layer; and
(e) a second skin layer adjacent to said core layer and on a side of said core layer opposite said first skin layer.

25. The multilayer film of claim 24, wherein said metalized layer is an aluminium layer.

26. The multilayer film of claim 24, wherein said film is biaxially oriented.

27. The multilayer film of claim 24, wherein said second skin layer comprises a polyolefin selected from the group consisting of ethylene-propylene random copolymer, ethylene-propylene-butylene terpolymer, propylene-butylene copolymer, and ethylene-propylene impact copolymer.

28. A process for producing a multilayer film comprising the steps of:
a) providing a multilayer melt of thermoplastic polymers comprising a terpolymer, said terpolymer comprising propylene, ethylene and C₄ to C₈ α-olefin wherein:
i) the amount of propylene in said terpolymer is at least 94 percent by weight;
ii) the melting temperature of said terpolymer is more than 140° C.; and
iii) the terpolymer has been produced in the presence of a Ziegler-Natta catalyst.
b) coextruding said terpolymer; and
c) cooling said terpolymer to form a multilayer sheet.

29. The process of claim 28, wherein the multilayer sheet is biaxially oriented.

30. The process of claim 28, wherein the multilayer sheet is metallised.

31. An article comprising a terpolymer, said terpolymer comprising propylene, ethylene and C₄ to C₈ α-olefin wherein:
i) the amount of propylene in said terpolymer is at least 94 percent by weight;
ii) the melting temperature of said terpolymer is more than 140° C.; and
iii) the terpolymer has been produced in the presence of a Ziegler-Natta catalyst;
wherein said article is a lamination packaging.
